(19) United States
(12) Patent Application Publication
(10) Pub. No.: US 2013/0145627 A1
(43) Pub. Date: Jun. 13, 2013

(54) Inner Cutter For Rotary Shaver

(71) Applicant: Rovcal, LLC, Madison, WI (US)

(72) Inventor: Maciej Murzynski, Verona, WI (US)

(73) Assignee: Rovcal, LLC, Madison, WI (US)

(21) Appl. No.: 13/707,782

(22) Filed: Dec. 7, 2012

Related U.S. Application Data
(60) Provisional application No. 61/568,767, filed on Dec. 9, 2011.

(51) Int. Cl. B26B 19/14

(52) U.S. Cl. CPC B26B 19/141
USPC 30/43.5; 30/346.51

(57) ABSTRACT

An inner cutter for a rotary shaver generally includes a blade having a base plate and a plurality of fingers unitarily formed with and bent upwardly relative to the base plate. Each of the fingers includes a front surface, a back surface opposite the front surface, and a top surface extending from the front surface to the back surface. The front surface and the top surface define a cutting edge, and the front surface has a curvilinear profile portion beneath the cutting edge.

### CROSS-REFERENCE TO RELATED APPLICATIONS

This application claims the benefit of U.S. Provisional Application No. 61/568,767 filed Dec. 9, 2011, which is incorporated herein in its entirety.

### BACKGROUND

The present invention relates generally to electric shavers and, more particularly, to an inner cutter for a rotary electric shaver.

Rotary electric shavers conventionally include a handle and a head mounted on the handle, and the head carries two or more sets of paired inner and outer cutters. The outer cutters, which are typically cup-shaped, are supported by a frame of the shaver head and typically define skin contacting surfaces of the shaver. Openings or slits formed in the outer cutters allow hair to protrude through the outer cutters as the shaver head is moved over the skin. Each inner cutter is housed in the shaver head below a respective outer cutter and in sliding engagement with the inner surface of the outer cutter. The inner cutters are rotatably driven by an electric motor, typically housed within the handle, whereby rotation of the inner cutters acts to cut hairs protruding through the outer cutters.

In some current rotary electric shaver constructions, each inner cutter has a plastic drive connector and metallic blade fastened to the drive connector. The drive connector is configured to operatively connect the inner cutter to a drive shaft protruding from the handle for rotation of the inner cutter during operation of the motor. While the geometry of the blade may affect the efficiency and comfort level of the shaving process, the blade geometry may also affect the ease and, therefore, the cost with which the inner cutter is manufactured. There is a need, therefore, for an inner cutter that facilitates an efficient and more comfortable shave, while also reducing a cost associated with manufacture.

### SUMMARY

In one embodiment, a rotary shaver generally includes a handle having a drive system, and a head connected to the handle. The head includes an outer cutter and an inner cutter disposed within the outer cutter and operatively connected to the drive system. The inner cutter includes a blade having a base plate and a plurality of fingers unitarily formed with and bent upwardly relative to the base plate. Each of the fingers has a front surface, a back surface opposite the front surface, and a top surface extending from the front surface to the back surface. The front surface and the top surface define a cutting edge, and the front surface has a curvilinear profile portion beneath the cutting edge.

In another embodiment, a cutter assembly for a rotary shaver generally includes an outer cutter and an inner cutter configured to be inserted into the outer cutter for rotation within the outer cutter. The inner cutter includes a blade having a base plate and a plurality of fingers unitarily formed with and bent upwardly relative to the base plate. Each of the fingers includes a front surface, a back surface opposite the front surface, and a top surface extending from the front surface to the back surface. The front surface and the top surface define a cutting edge, and the front surface has a curvilinear profile portion beneath the cutting edge.

In yet another embodiment, an inner cutter for a rotary shaver generally includes a blade having a base plate and a plurality of fingers unitarily formed with and bent upwardly relative to the base plate. Each of the fingers includes a front surface, a back surface opposite the front surface, and a top surface extending from the front surface to the back surface. The front surface and the top surface define a cutting edge, and the front surface has a curvilinear profile portion beneath the cutting edge.

In yet another embodiment, a blade for an inner cutter of a rotary shaver generally includes a base plate and a plurality of fingers unitarily formed with and bent upwardly relative to the base plate. Each of the fingers includes a front surface, a back surface opposite the front surface, and a top surface extending from the front surface to the back surface. The front surface and the top surface define a cutting edge, and the front surface has a curvilinear profile portion beneath the cutting edge.

### BRIEF DESCRIPTION OF THE DRAWINGS

FIG. 1 is a perspective view of one embodiment of an inner cutter;

FIG. 2 is a perspective view of a drive cap of the inner cutter of FIG. 1;

FIG. 3 is a top plan view of the drive cap of FIG. 2;

FIG. 4 is a side elevation of the drive cap of FIG. 2;

FIG. 5 is a perspective view of a blade of the inner cutter of FIG. 1;

FIG. 6 is a top plan view of the blade of FIG. 5;

FIG. 7 is a side elevation of the blade of FIG. 5; and

FIG. 8 is an enlarged side elevation of a portion of the blade taken within area 8 of FIG. 7 when the blade is disposed within an outer cutter.

Corresponding reference characters indicate corresponding parts throughout the several views of the drawings.

### DETAILED DESCRIPTION OF THE PREFERRED EMBODIMENTS

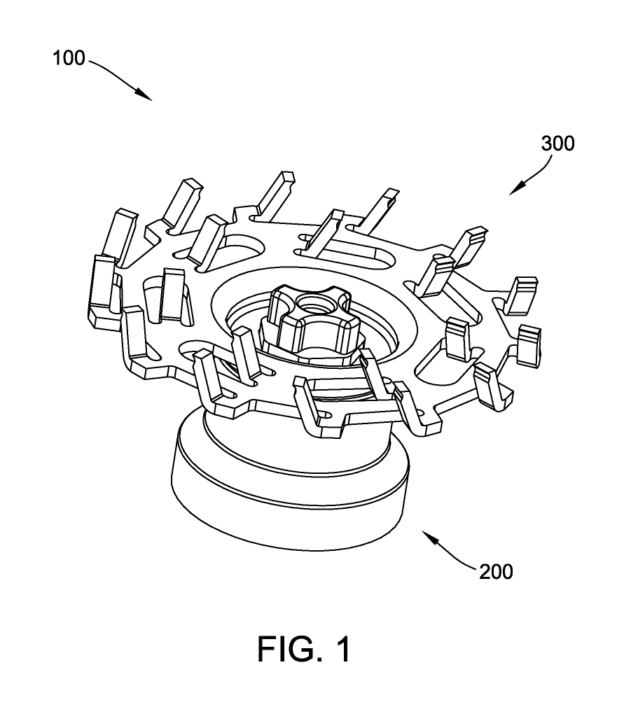

Referring now to the drawings, and in particular to FIG. 1, an inner cutter according to one embodiment is generally indicated by the reference numeral 100. The inner cutter 100 includes a drive cap, indicated generally at 200, and a blade, indicated generally at 300.

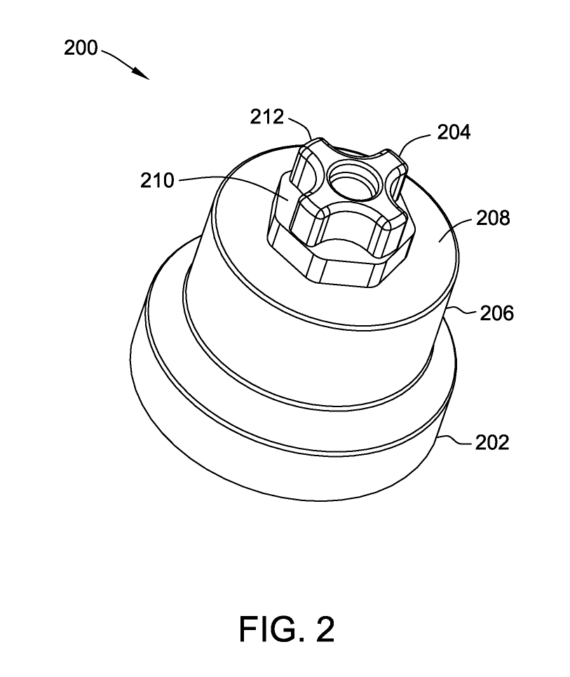

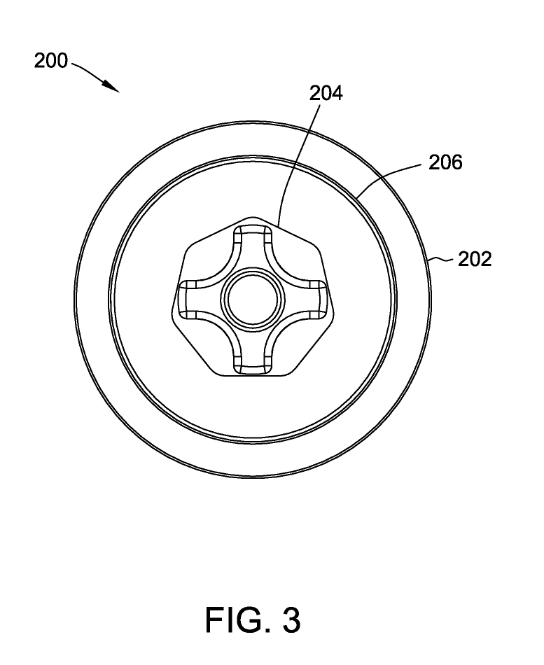

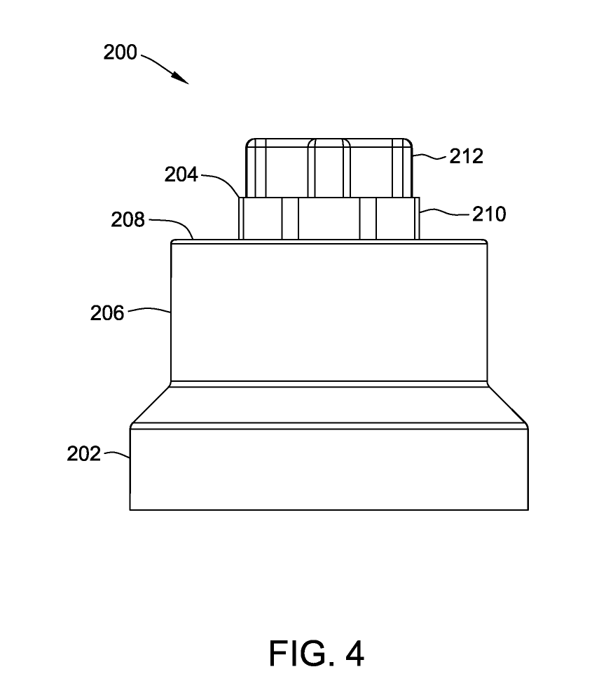

With reference now to FIGS. 2-4, the illustrated cap 200 includes a lower portion 202, an upper portion 204, and an intermediate portion 206 between the lower portion 202 and the upper portion 204. The lower and intermediate portions 202, 206 are generally cylindrical, and the intermediate portion 206 has a rim 208 from which the upper portion 204 projects. The illustrated upper portion 204 has a base 210 and a tip 212. The base 210 is integrally formed with the rim 208 of the intermediate portion 206, and the tip 212 is integrally formed with the base 210. The base 210 has a generally polygonal profile (e.g., a heptagonal profile in the preferred embodiment), and the tip 212 has a generally cross-shaped or plus-shaped profile. The base 210 is therefore configured for securing the blade 300 to the cap 200 (as described below).

With this configuration, the inner cutter 100 may be inserted into an outer cutter (not shown) of a shaver head (not shown) suitably connected to a shaver handle (not shown). Because shaver heads and/or shaver handles typically house components of a shaver drive system (e.g., a motor, a gear arrangement, and/or a drive shaft), at least the lower portion 202 of the cap 200 is hollow to receive a drive pin for operatively connecting the inner cutter 100 (e.g., the blade 300) to the shaver drive system. Additionally, the generally cross-shaped or plus-shaped tip 212 is configured for aligning the inner cutter 100 inside of the outer cutter during rotation of the inner cutter 100 within the outer cutter during operation of the shaver drive system.

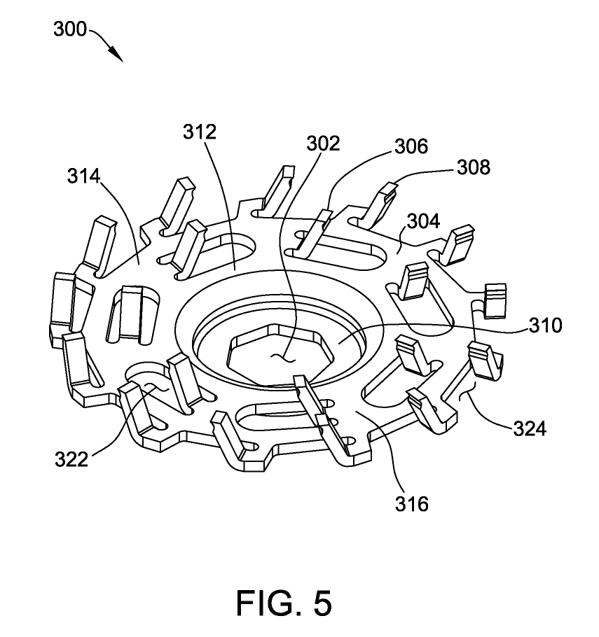

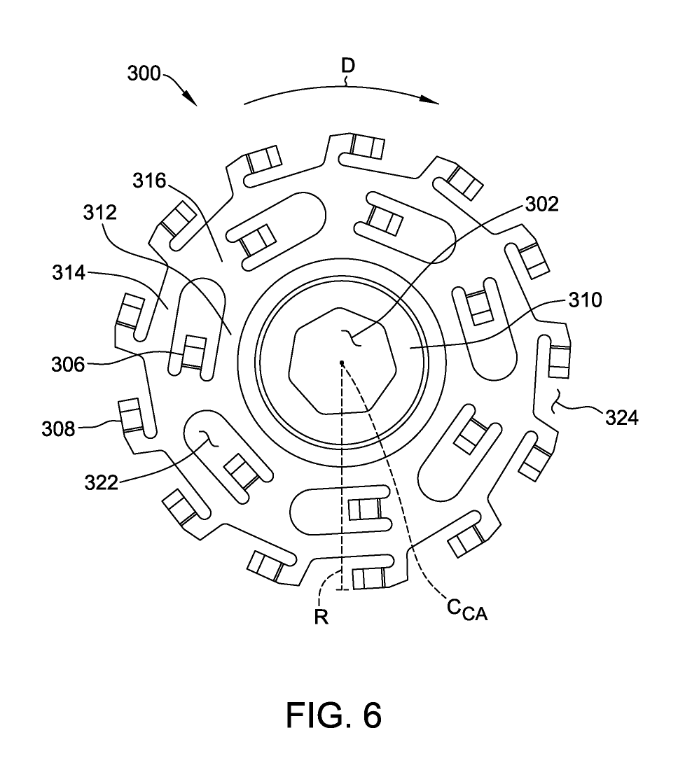

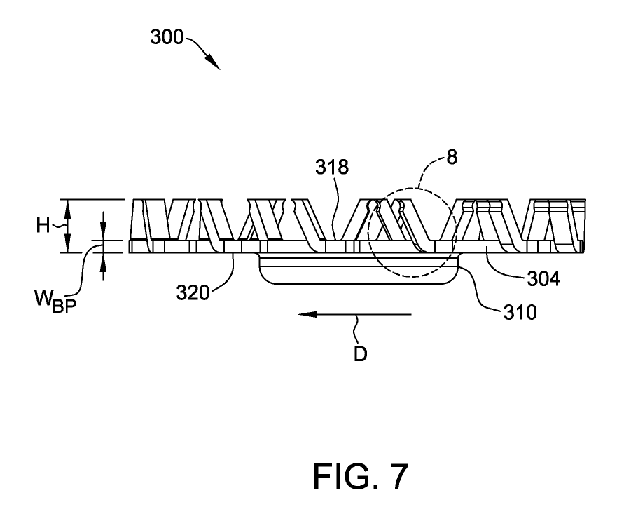

Referring now to FIGS. 5-7, the illustrated blade 300 has a generally annular shape with a polygonal (e.g., heptagonal) central aperture 302, and the blade 300 has an intended rotational direction D. The central aperture 302 has a center point C_{CA} (FIG. 6), thereby defining a first dimension R (e.g., a radius in the illustrated embodiment) of the annular blade 300. In other embodiments, the blade 300 may have any suitable shape that facilitates enabling the blade 300 to function as described herein.

The illustrated blade 300 includes a base plate 304, a plurality of radially inner fingers 306, and a plurality of radially outer fingers 308. The base plate 304 has a middle region 310, an inner ring region 312, an outer ring region 314, and a plurality of spoke regions 316. The middle region 310, the inner ring region 312, the outer ring region 314, and the spoke regions 316 are formed integrally together in this embodiment. In other embodiments, the middle region 310, the inner ring region 312, the outer ring region 314, and/or the spoke regions 316 may be formed separately from, and connected to, one another using any suitable connection (e.g., a welded connection). Additionally, the illustrated base plate 304 has a top surface 318 and a bottom surface 320 that are substantially parallel to one another and define a substantially constant width W_{BP} of the base plate 304.

The middle region 310 is generally cup-shaped and defines the aperture 302. The inner ring region 312 is radially outward of, and circumscribes, the cup-shaped middle region 310; the outer ring region 314 is spaced radially outward of, and circumscribes, the inner ring region 312; and the spoke regions 316 extend radially between the inner ring region 312 and the outer ring region 314 to connect the inner ring region 312 to the outer ring region 314. The spoke regions 316 are circumferentially spaced apart from one another about the annular blade 300 to define a plurality of generally U-shaped cutouts 322.

The blade 300 is configured to be connected to the cap 200 (FIG. 1) using any suitable method. In the illustrated embodiment, the polygonal aperture 302 is sized to receive the polygonal base 210 of the cap 200. As such, to fasten the blade 300 to the cap 200, the upper portion 204 of the cap 200 is inserted into the aperture 302 of the blade 300 until the bottom of the cup-shaped middle region 310 is seated on the rim 208. Because the polygonal shape of the base 210 is keyed to the polygonal shape of the aperture 302 (e.g., both have similar heptagonal shapes), the base 210 can be inserted into the aperture 302, but the base 210 cannot then be rotated relative to the base plate 304 (i.e., the cap 200 is configured to transmit rotational motion from the drive system of the shaver to the blade 300 during operation of the shaver). With the base plate 304 seated on the rim 208, the base 210 is heat staked or ultrasonically staked between the arms of the cross-shaped or plus-shaped tip 212. This heat staking or ultrasonic staking deforms portions of the base 210 over the perimeter of the aperture 302 to create an interference fit between the cap 200 and the blade 300 once the deformed portions of the base 210 harden, thereby connecting the blade 300 to the cap 200.

The fingers 306, 308 of the blade 300 are unitarily formed with, and bent upwardly relative to, the base plate 304, as described in more detail below. In the illustrated embodiment, the blade 300 has seven radially inner fingers 306 and thirteen radially outer fingers 308. This number of fingers 306, 308 provides functional benefits over conventional inner cutters. For example, providing seven radially inner fingers 306 and thirteen radially outer fingers 308 enables the fingers 306, 308 to be fabricated with geometries (e.g., spacing, lengths, bending angles, rake angles, etc.) that facilitate easier manufacture, more efficient operation, and increased useful life of the blade 300 (as described below), while still enabling the blade 300 to fit within conventionally sized outer cutters. However, in alternative embodiments, the blade 300 may have any suitable number of fingers 306, 308 that facilitates enabling the blade 300 to function as described herein.

Each of the radially inner fingers 306 extends from one of the spoke regions 316 and into a corresponding one of the U-shaped cut-outs 322. Each of the radially outer fingers 308 extends from the outer ring region 314 to form generally L-shaped cutouts 324 that are circumferentially spaced apart from one another about the periphery of the annular blade 300. In other embodiments, the cut-outs 322, 324 may have any suitable shapes.

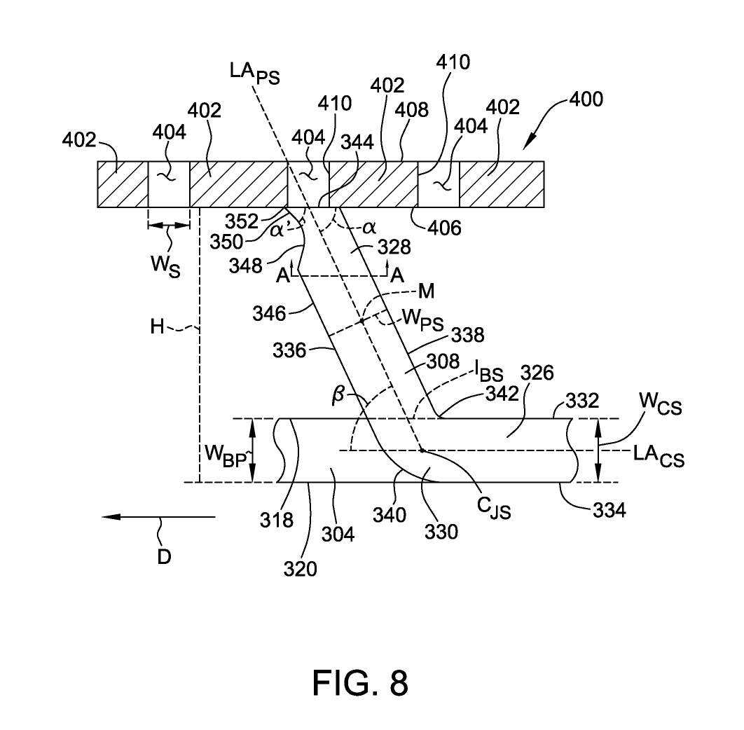

FIG. 8 is an enlarged side elevation of one of the radially outer fingers 308 when the blade 300 is inserted into an outer cutter, indicated generally at 400. The radially inner fingers 306 are configured in a like manner.

The outer cutter 400 has a plurality of bridges 402 that are spaced apart to define a plurality of slits 404. Each bridge 402 has an inner surface 406, an outer surface 408, and a pair of side surfaces 410 that extend from the inner surface 406 to the outer surface 408. The outer surfaces 408 of the bridges 402 are substantially coplanar and collectively define a skin contacting area of the outer cutter 400, and the inner surfaces 406 of the bridges 402 are substantially coplanar and collectively define an inner cutter contacting area of the outer cutter 400. Each slit 404 has a width W_{S} defined between side surfaces 410 of adjacent bridges 402. During a shaving operation, the inner cutter 100 is disposed within the outer cutter 400 with the drive cap 200 operatively connected to the motor of the shaver such that, when the skin contacting area of the outer cutter 400 is placed in contact with skin, hairs may enter the slits 404 to be cut by the inner cutter 100 as the inner cutter 100 rotates in contact with the inner cutter contacting area of the outer cutter 400.

Still referring to FIG. 8, each finger 306, 308 of the blade 300 has a connecting segment 326 and a projecting segment 328 that are integrally formed together at a joint segment 330. The connecting segment 326 is also integrally formed with the base plate 304 such that the connecting segment 326 links the projecting segment 328 to the base plate 304. The connecting segment 326 has a centerline, lengthwise longitudinal axis LA_{CS}, and the projecting segment 328 has a centerline, lengthwise longitudinal axis LA_{PS}. The longitudinal axes LA_{CS}, LA_{PS} intersect at a center C_{JS} of the joint segment 330.

In the illustrated embodiment, the connecting segment 326 has a top surface 332 and a bottom surface 334 defining a width W_{CS} of the connecting segment 326. The top surface 332 of the connecting segment 326 is substantially coplanar with the top surface 318 of the base plate 304 and parallel to the longitudinal axis LA_{CS}, and the bottom surface 334 of the connecting segment 326 is substantially coplanar with the bottom surface 320 of the base plate 304 and parallel to the longitudinal axis LA_{CS}. As such, the width W_{CS} of the connecting segment 326 is substantially the same as the width W_{BP} of the base plate 304. In other embodiments, the connecting segment 326 may have any suitable width W_{CS} relative to the width W_{BP} of the base plate 304.

The illustrated projecting segment 328 has a front surface 336 and a back surface 338 defining a width W_{PS} of the projecting segment 328. The front surface 336 faces toward the direction D of rotation, and the back surface 338 faces away from the direction D of rotation. The front surface 336 is joined with the bottom surface 334 of the connecting segment 326 at a lower curved surface 340, and the back surface 338 is joined with the top surface 332 of the connecting segment 326 at an upper curved surface 342. The projecting segment 328 also has a top surface 344 extending between the front surface 336 and the back surface 338. A length of the projecting segment 328 is defined from an imaginary bottom surface I_{BS} of the projecting segment 328 (which is substantially coplanar with the top surface 318 of the base plate 304 and the top surface 332 of the connecting segment 326) to the top surface 344 of the projecting segment 328 along the longitudinal axis LA_{PS}. The length of the projecting segment 328 has a midpoint M.

The top surface 344 of the projecting segment 328 is oriented to be substantially parallel with, and slide smoothly against, the inner surfaces 406 of the outer cutter 400 during operation of the shaver (i.e., the top surface 344 does not slope relative to the inner surfaces 406 of the outer cutter 400). As such, the top surface 344 is acutely oriented relative to the front surface 336 and is obtusely oriented relative to the back surface 338, as described in more detail below. Additionally, because the top surface 344 is oriented to be substantially parallel with the inner surfaces 406 of the outer cutter 400, the entire area of the top surface 344 is configured to slide against the inner surfaces 406 of the outer cutter 400 during operation of the shaver. In other embodiments, the top surface 344 may be oriented such that only a portion of the top surface 344 is configured to slide against the inner surfaces 406 of the outer cutter 400.

The projecting segment 328 is bent upwardly relative to the connecting segment 326 at a bend angle β and is pointed in the direction D of rotation of the blade 300. More specifically, the longitudinal axis LA_{PS} of the projecting segment 328 is acutely oriented in the direction D of rotation at the bend angle β relative to the longitudinal axis LA_{CS} of the connecting segment 326. As such, the longitudinal axis LA_{PS} forms a top angle α with the top surface 344, wherein the bend angle β and the top angle α are equal alternate interior angles because the top surface 344 is parallel to the longitudinal axis LA_{CS}. In the illustrated embodiment, the bend angle β is 65° and, therefore, the top angle α is also 65°. In other embodiments, the bend angle β may be defined by the following expression: 55°<β≦65°. Alternatively, the bend angle β may be greater than 65°.

By having the bend angle β be greater than 55°, the fingers 306, 308 can be shortened, thereby providing a lower profile height H for the blade 300 (i.e., the height H of the blade 300, from the bottom surface 320 of the base plate 304 to the top surfaces 344 of the projecting segments 328, is 2.15 mm in the preferred embodiment, which is less than the height of conventional blades). In other embodiments, the blade 300 may have any suitable height H that facilitates providing the blade 300 with the benefits described herein.

By providing the blade 300 with a lower profile height H, the base plate 304 of the blade 300 can be located closer to the inner surfaces 406 of the outer cutter 400 when the blade 300 is inserted into the outer cutter 400, thereby strengthening the blade 300 and providing a more compact blade assembly. For example, with shorter fingers 306, 308 and, therefore, a lower profile height H, the circumferential spacing between the radially inner fingers 306 and the circumferential spacing between the radially outer fingers 308 are greater, thereby facilitating more efficient manufacture of the blade 300 and an increased useful life of the blade 300. More specifically, the spoke regions 316 between circumferentially adjacent radially inner fingers 306 are stronger because the spoke regions 316 can be made larger, meaning that the spoke regions 316 are configured to better withstand the stress and fatigue associated with manufacturing the blade 300 (e.g., the stamping and the bending). Thus, the likelihood that the blade 300 will fracture during the manufacturing process is reduced. Additionally, the shorter fingers 306, 308 and, therefore, the lower profile height H facilitate making the joint segments 330 stronger, which also facilitates more efficient manufacture of the blade 300 and an increased useful life of the blade 300 (e.g., shorter fingers 306, 308 lessen the stress that is placed on the joint segments 330 when the projecting segments 328 are bent upward during manufacture such that the joint segments 330 are less likely to fracture during manufacture and are better equipped to withstand the stress placed upon them during use of the shaver).

The illustrated front surface 336 has a linear profile portion 346 and a curvilinear profile portion 348 (i.e., an indent). The linear profile portion 346 is substantially parallel to the longitudinal axis LA_{PS} and extends from the lower curved surface 340 to the curvilinear profile portion 348. The curvilinear profile portion 348 extends from the linear profile portion 346 to the top surface 344. In this manner, the curvilinear profile portion 348 is entirely above the midpoint M, which facilitates more efficient manufacture of the blade 300 and an increased useful life of the blade 300 (e.g., less material is removed from the blade 300, meaning that manufacturing the blade 300 is easier and the structural integrity of the blade 300 is less affected during manufacture when compared to having the curvilinear profile portion 348 extend below the midpoint M).

The curvilinear profile portion 348 is contoured such that an upper region 350 of the curvilinear profile portion 348 is oriented at a rake angle α′ relative to the top surface 344, thereby defining a cutting edge 352 of the projecting segment 328. The rake angle α′ is less than the top angle α. In the illustrated embodiment, the rake angle α′ is 45° (with the top angle α being 65°, as referenced above), and the cutting edge 352 is 0.01 mm. In other embodiments, the following expression may be used to define the rake angle α′: 30°α′<55°, where the cutting edge 352 is less than 0.01 mm if 30°α′<45°, the cutting edge 352 is 0.01 mm if α′=45°, and the cutting edge 352 is greater than 0.01 mm if 45°<α′<55°.

If the profile of the front surface 336 had been entirely linear and parallel to the longitudinal axis LA_{PS} from the lower curved surface 340 to the top surface 344 (e.g., if the back surface 338, not the front surface 336, had the curvilinear profile portion 348) with the top surface 344 oriented to be parallel with the inner surfaces 406 of the outer cutter 400, the rake angle α′ would necessarily be equal to the top angle α (which is necessarily equal to the bend angle β, as referenced above), meaning that the rake angle α′ would be dictated by the bend angle β. For example, if the bend angle β was 55°, the rake angle α′ would necessarily be 55°. In contrast, the illustrated embodiment alleviates this problem because the curvilinear profile portion 348 is located on the front surface 336 (not the back surface 338), meaning that the rake angle α′ is not dictated by the bend angle β but, rather, the rake angle α′ can be selected independently of the bend angle β. In fact, the illustrated rake angle α′ is 45°, while the illustrated bend angle β is 65° (i.e., the rake angle α′ has been optimized to suit cutting efficiency, while the bend angle β has been optimized to suit the lower profile nature and/or the increased structural integrity of the blade 300).

The illustrated back surface 338 has a linear profile that is substantially parallel with the longitudinal axis LA_{PS} from the upper curved surface 342 to the top surface 344 (i.e., in this embodiment, the back surface 338 is not indented and is not bent). As such, the width W_{PS} of the projecting segment 328 is substantially constant from the curved surfaces 340, 342 through the midpoint M and up to the curvilinear profile portion 348. Also, the curvilinear profile portion 348 is contoured such that the surface area of the top surface 344 is less than the surface area of a section of the projecting segment 328 taken below the curvilinear profile portion 348 and parallel to the top surface 344 (e.g., is less than the surface area of a section taken along line A-A). Yet, the top surface 344 is nevertheless sized to span the width W_{S} of the slits 404 of the outer cutter 400. For example, in the illustrated embodiment, the top surface 344 is 0.43 mm wide, while the width W_{S} of the slits 404 is 0.3 mm. As such, the overall surface area of the blade 300 that is in contact with the inner surfaces 406 of the outer cutter 400 during operation of the shaver is reduced, thereby reducing friction, reducing heat, and prolonging battery life during operation of the shaver. Yet, because the top surface 344 remains wider than the slits 404 of the outer cutter 400, the top surface 344 of each projecting segment 328 is configured to completely span each of the slits 404.

In the illustrated embodiment, the blade 300 is fabricated from a rigid, metallic material using the following sequential processes: forming, stamping, bending, hardening/tempering, tumbling, and Lapp cutting. The illustrated cap 200 is fabricated from a synthetic or semi-synthetic, organic-based material (e.g., a “plastic” material) using a molding process. It is understood, however, that the blade 300 and/or the cap 200 may be fabricated from any suitable materials using any suitable manufacturing processes without departing from the scope of this invention.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A rotary shaver comprising:
a handle comprising a drive system; and
a head connected to the handle, the head comprising an outer cutter and an inner cutter disposed within the outer cutter and operatively connected to the drive system, wherein the inner cutter comprises a blade comprising a base plate and a plurality of fingers unitarily formed with and bent upwardly relative to the base plate, each of the fingers comprising:
a front surface;
a back surface opposite the front surface; and
a top surface extending from the front surface to the back surface, wherein the front surface and the top surface define a cutting edge and wherein the front surface has a curvilinear profile portion beneath the cutting edge.

2. The rotary shaver set forth in claim 1 wherein the back surface is not indented and is not bent.

3. The rotary shaver set forth in claim 1 wherein the outer cutter comprises a plurality of spaced-apart bridges that each comprises an outer surface, an inner surface, and a pair of side surfaces such that the bridges define a plurality of spaced-apart slits in the outer cutter, wherein the top surface is oriented to be parallel with and to slide against the inner surfaces of the outer cutter.

4. The rotary shaver set forth in claim 3 wherein the top surface has a surface area and wherein each of the fingers is sized such that a section of the finger, taken below the curvilinear profile portion and parallel to the top surface, has a surface area that is larger than the surface area of the top surface.

5. The rotary shaver set forth in claim 4 wherein each of the slits of the outer cutter has a width and wherein the top surface is sized to span the width.

6. The rotary shaver set forth in claim 1 wherein each of the fingers comprises:
a connecting segment having a first longitudinal axis; and
a projecting segment having a second longitudinal axis, wherein the projecting segment is unitarily formed with and bent upwardly relative to the connecting segment such that the first longitudinal axis and the second longitudinal axis are oriented at a bend angle relative to one another.

7. The rotary shaver set forth in claim 6 wherein the projecting segment has an imaginary base surface and a length defined along the second longitudinal axis from the imaginary base surface to the top surface, the length having a midpoint such that the curvilinear profile portion is entirely above the midpoint.

8. The rotary shaver set forth in claim 6 wherein the curvilinear profile portion comprises an upper region oriented to define a rake angle αt the cutting edge, the rake angle being different than the bend angle.

9. An inner cutter for a rotary shaver, said inner cutter comprising a blade, wherein the blade comprises a base plate and a plurality of fingers unitarily formed with and bent upwardly relative to the base plate, each of the fingers comprising:
a front surface;
a back surface opposite the front surface; and
a top surface extending from the front surface to the back surface, wherein the front surface and the top surface define a cutting edge and wherein the front surface has a curvilinear profile portion beneath the cutting edge.

10. The inner cutter set forth in claim 9 wherein the back surface is not indented and is not bent.

11. The inner cutter set forth in claim 9 wherein the base plate comprises a top surface and a bottom surface, the top surface of each of the fingers being oriented parallel with the top surface of the base plate.

12. The inner cutter set forth in claim 11 wherein the top surface of each of the fingers has a surface area and wherein each of the fingers is sized such that a section of the finger, taken below the curvilinear profile portion and parallel to the top surface of the finger, has a surface area that is larger than the surface area of the top surface of the finger.

13. The inner cutter set forth in claim 9 wherein each of the fingers comprises:
a connecting segment having a first longitudinal axis; and
a projecting segment having a second longitudinal axis, wherein the projecting segment is unitarily formed with and bent upwardly relative to the connecting segment such that the first longitudinal axis and the second longitudinal axis are oriented at a bend angle relative to one another.

14. The inner cutter set forth in claim 13 wherein the bend angle is 65°.

15. The inner cutter set forth in claim 13 wherein the bend angle is greater than 55° and less than or equal to 65°.

16. The inner cutter set forth in claim 13 wherein the projecting segment has an imaginary base surface and a length defined along the second longitudinal axis from the imaginary base surface to the top surface of the finger, the length having a midpoint such that the curvilinear profile portion is entirely above the midpoint.

17. The inner cutter set forth in claim 13 wherein the curvilinear profile portion comprises an upper region oriented to define a rake angle αt the cutting edge, wherein the rake angle is different than the bend angle.

18. The inner cutter set forth in claim 17 wherein the rake angle is 45°.

19. The inner cutter set forth in claim 17 wherein the rake angle is greater than or equal to 30° and less than 45°.

20. The inner cutter set forth in claim 17 wherein the rake angle is greater than 45° and less than 55°.
